(19) United States
(12) Patent Application Publication
(10) Pub. No.: US 2013/0105241 A1
(43) Pub. Date: May 2, 2013

(54) ELECTRIC VEHICLE POWERTRAIN SUSPENSION SYSTEM

(71) Applicants: Donald J. Christian, Fremont, CA (US); Richard Hoyle, Clarkston, MI (US); David Brian TenHouten, Los Angeles, CA (US)

(72) Inventors: Donald J. Christian, Fremont, CA (US); Richard Hoyle, Clarkston, MI (US); David Brian TenHouten, Los Angeles, CA (US)

(73) Assignee: Coda Automotive, Inc., Los Angeles, CA (US)

(21) Appl. No.: 13/282,045

(22) Filed: Oct. 26, 2011

(51) Int. Cl. B60K 17/00

(52) U.S. Cl. 180/337

(57) ABSTRACT

An electric vehicle is provided which includes a frame, a powertrain, and a powertrain suspension system mounting the powertrain to the frame. The powertrain suspension system includes a first and second mount, each mount pivotally coupling the powertrain to the frame, where the first and second mounts are constructed to be weight bearing mounts such that the powertrain hangs from the first and second mounts. The powertrain system further includes a third mount coupling the powertrain to the frame, where the third mount is constructed and arranged to be a non-weight bearing mount. The powertrain suspension system may include a fourth mount coupling the powertrain to the frame, and the first, second, third and fourth mounts may be arranged in a substantially tetrahedral shape.

### FIELD

The present disclosure is directed to an electric vehicle having a powertrain suspension system configured such that the powertrain hangs from the frame of the vehicle.

### BACKGROUND

A conventional internal combustion engine vehicle has a powertrain suspension system configured to reduce noise and vibration. Noise and vibration may be caused by starting/stopping of the vehicle, torque changes, terrain and load-based impulses, or imbalances in the powertrain or wheels. The powertrain suspension system includes a plurality of vibration isolators, or mounts, which attach the powertrain to the vehicle frame. Each mount typically includes a resilient member configured to absorb noise and/or vibration so that the noise and/or vibration is not felt by the passengers in the vehicle.

There is a need for a powertrain suspension system that is more suitable for electric vehicles (EVs).

### SUMMARY

The inventors recognized that problems may arise when a powertrain suspension system designed for use with an internal combustion engine vehicle is integrated into an electric vehicle (EV). In particular, as set forth below, the inventors recognized that there are key differences between an EV and an internal combustion engine vehicle that are not adequately addressed by a conventional powertrain suspension system designed for an internal combustion engine vehicle. As set forth in greater detail below, the inventors discovered that hanging the powertrain from the frame of the vehicle may help to compensate for some of the differences between an EV and an internal combustion engine. Also, as discussed below, the inventors also discovered that arranging the powertrain suspension system mounts to form a substantially tetrahedral shape may also be advantageous in an EV, whether alone or in combination with hanging the powertrain from the frame.

According to one aspect, an electric vehicle is provided. The electric vehicle includes a frame, a powertrain, and a powertrain suspension system mounting the powertrain to the frame. The powertrain suspension system includes first and second mounts cooperating to pivotally couple the powertrain to the frame, with the first and second mounts being weight bearing mounts such that the powertrain hangs from the first and second mounts. The powertrain suspension system further includes a third mount coupling the powertrain to the frame, the third mount being a non-weight bearing mount.

According to another aspect, an electric vehicle is provided. The electric vehicle includes a frame, a powertrain mounted to the frame, and a powertrain suspension system. The powertrain suspension system includes first and second mounts cooperating to pivotally couple the powertrain to the frame, third and fourth mounts coupling the powertrain to the frame, where the first, second, third and fourth mounts are arranged to form a substantially tetrahedral shape.

Various embodiments of the present invention provide certain advantages. Not all embodiments of the invention share the same advantages and those that do may not share them under all circumstances.

Further features and advantages of the present invention, as well as the structure of various embodiments that incorporate aspects of the invention are described in detail below with reference to the accompanying drawings.

### BRIEF DESCRIPTION OF DRAWINGS

The foregoing and other objects and advantages of the invention will be appreciated more fully from the following drawings, wherein like reference characters designate like features, in which:

FIG. 1 is a front schematic illustration of a portion of an electric vehicle illustrating a powertrain suspension system according to one embodiment;

FIG. 2 is the schematic illustration shown in FIG. 1 with the powertrain omitted;

FIG. 3 is a rear schematic illustration of the powertrain suspension system shown in FIG. 1;

FIG. 4 is the schematic illustration shown in FIG. 3 with the transaxle removed;

FIG. 5 is another schematic illustration of a portion of an electric vehicle illustrating a powertrain suspension system according to one embodiment; and

FIG. 6 is a schematic illustration of the mounts in a powertrain suspension system according to one embodiment.

### DETAILED DESCRIPTION

As mentioned above, the inventors recognized that a powertrain suspension system designed for an internal combustion engine vehicle may not be suitable for an electric vehicle (EV). In particular, in a conventional internal combustion engine vehicle, the powertrain rests on top of the vehicle frame.

The inventors recognized that there are differences between an EV and an internal combustion engine vehicle that are not adequately addressed by a conventional powertrain suspension system designed for an internal combustion engine vehicle. First, unlike an internal combustion engine, in an EV, there may be a substantially instantaneous onset of high torque. These rapid torque impulses may inflict damage on the powertrain, may decrease vehicle reliability and durability, and may also cause passenger-perceived problems such as noise and vibration. Second, in an EV, there may be high frequency torque reversals and the torque can alternate between a maximum positive and a maximum negative torque. Such torque reversals can occur at various shaft speeds with reversal rates greater than 5 Hz. In contrast, under most conditions, an internal combustion engine creates only positive torque. In an EV, each reversal generates a torque impulse that can cause noise and/or vibration. The greater peak-to-peak amplitude and higher reversal frequency poses new and unique challenges to the durability of an EV, and introduces high-amplitude torque impulses into the vehicle. These impulses have very broad frequency spectra that test the ability of the vehicle structure to reliably withstand. Third, the ratio of the powertrain mass relative to the total vehicle mass of an EV is typically less than similar ratios for internal combustion engine vehicles. Thus, the powertrain may have more resonant peaks at higher frequencies, with greater potential to propagate noise and harshness effect into the vehicle. For at least these reasons, a powertrain suspension system designed for an internal combustion engine vehicle, where the powertrain rests on top of the vehicle frame, may not be adequate for dissipating vibration in an EV.

As set forth in greater detail below, the inventors discovered that hanging the powertrain from the frame of the vehicle may help to address some of the differences between an EV and an internal combustion engine vehicle. One aspect of the invention is directed to a powertrain suspension system that has at least two weight-bearing mounts and the powertrain is configured to hang downwardly from the two weight-bearing mounts. The powertrain suspension system may further include at least one non-weight bearing mount configured for vibration isolation. Though these mounts are below the powertrain, the primary purpose of these mounts is vibration isolation rather than weight bearing.

As set forth below, another aspect of the invention is directed to a powertrain suspension system that has at least four mounts coupling the powertrain to the vehicle frame, where the mounts are arranged to form a substantially tetrahedral shape. In one embodiment, the first and second mounts are positioned along a line that is substantially parallel to a wheel axis of the vehicle, and the third and fourth mounts are positioned along a line that is substantially perpendicular to the line defined by the first and second mounts, and is also substantially parallel to the direction of vehicle movement.

The embodiments described herein may be used with any type of EV. For example, it is contemplated that that vehicle is powered exclusively by electricity. It is also contemplated that the vehicle is a hybrid electric vehicle, and may, for example be a plug-in hybrid electric vehicle. The vehicle may be powered by a combination of batteries, fuel cells, and/or combustible fuel such as gasoline or diesel.

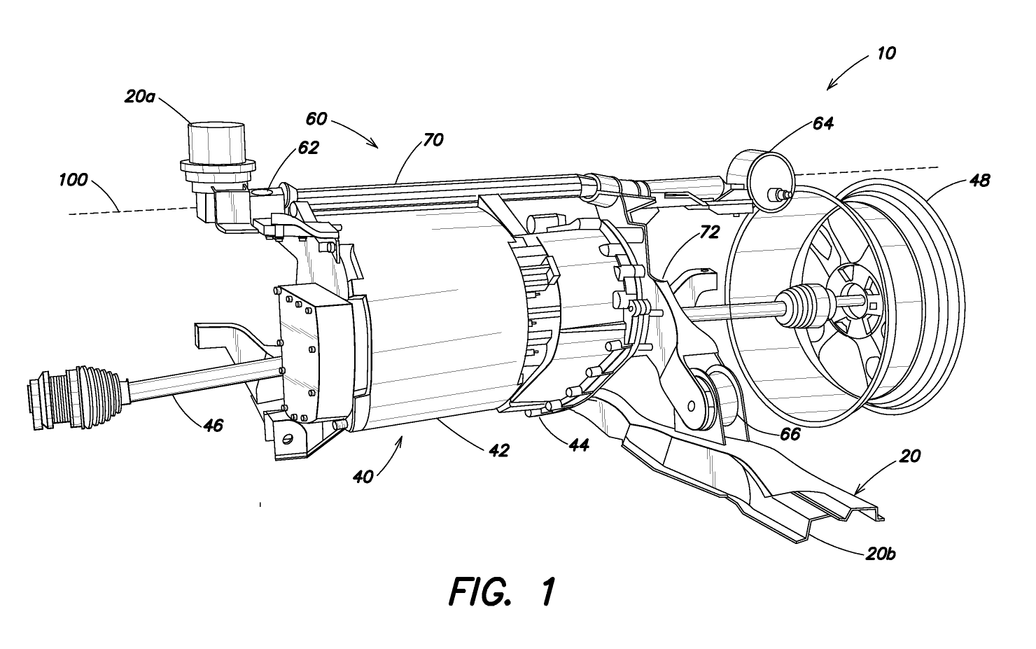

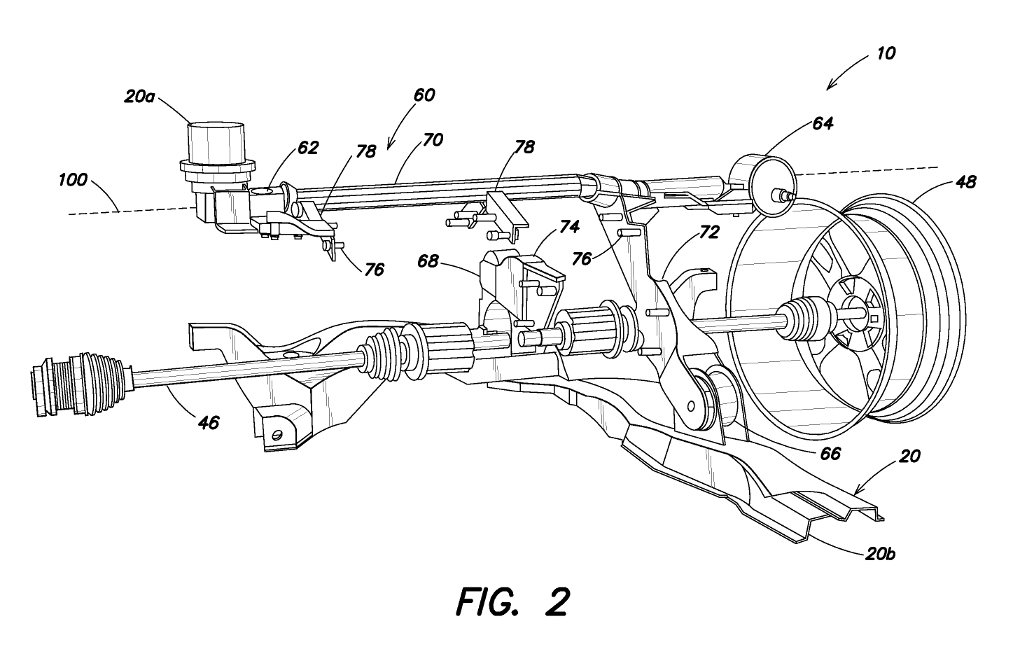

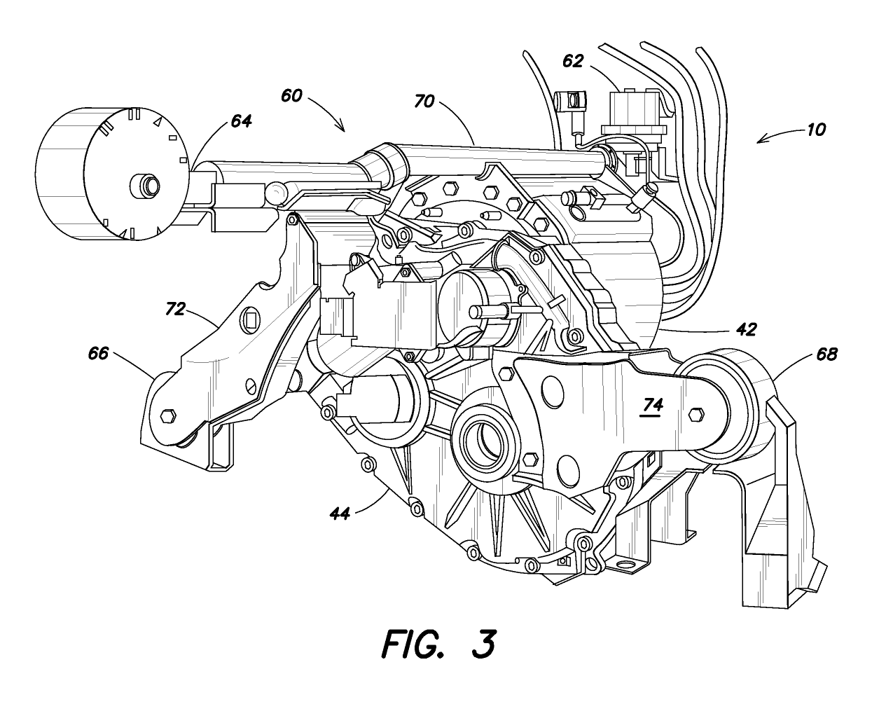

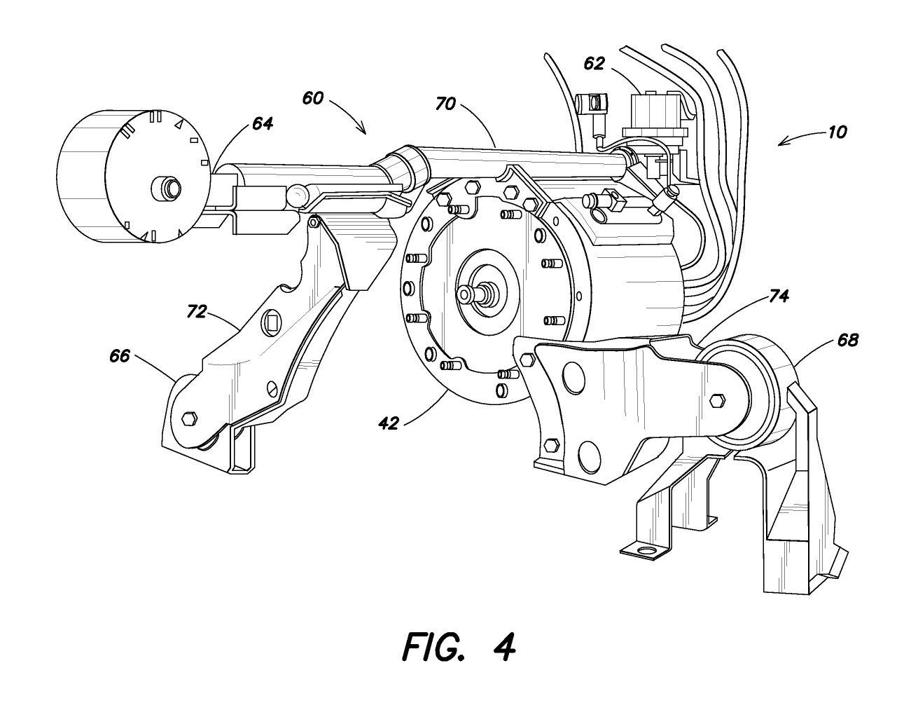

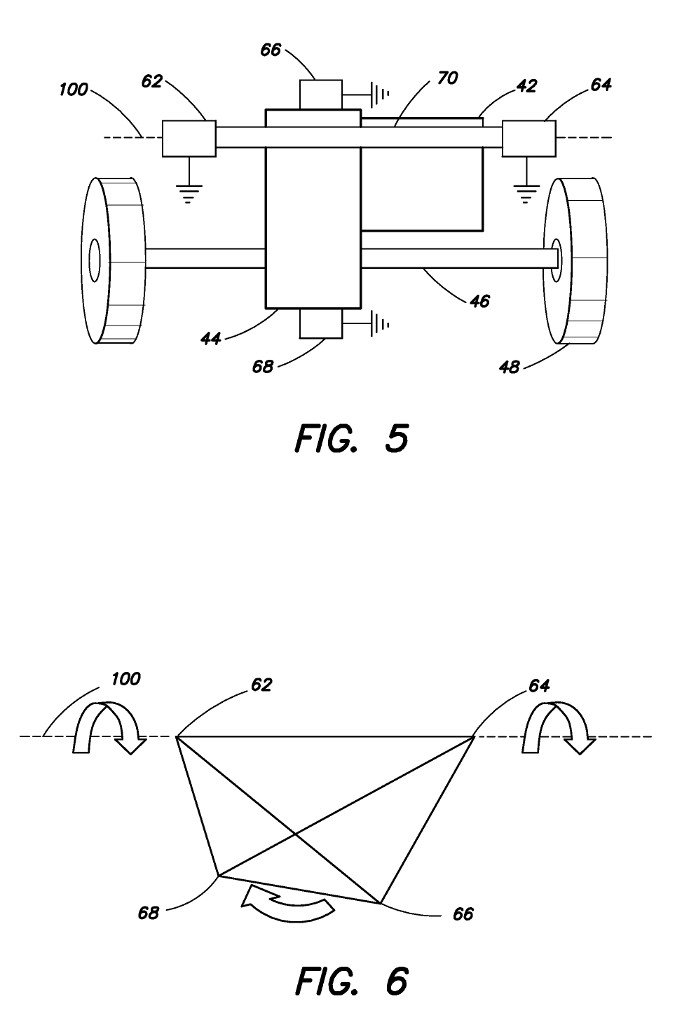

Turning now to the figures, FIGS. 1-4 are schematic illustrations of a portion of an exemplary EV 10. The EV 10 has a vehicle frame 20, a powertrain 40 and a powertrain suspension system 60. One of ordinary skill in the art would recognize that the EV 10 includes many other additional components, but for clarity, only those components necessary for the understanding of the invention are illustrated in the figures or described herein. Furthermore, the powertrain 40 is omitted from FIG. 2, and the transaxle 44 is omitted from FIG. 4 to better illustrate the surrounding components. In one illustrative embodiment, the frame 20 includes at least a first frame portion 20a positioned above the powertrain 40 and a second frame portion 20b positioned below the powertrain 40.

As illustrated, the powertrain suspension system 60 includes a plurality of mounts 62, 64, 66, 68 for mounting the powertrain 40 to the vehicle frame 20a, 20b. The mounts (i.e. vibration isolators) are discussed in greater detail below. However, one of ordinary skill in the art would recognize that the mounts 62, 64, 66, 68 are configured to dissipate vibration/noise generated by the powertrain, to prevent such vibration/noise from being transmitted into other components of the EV. In this embodiment shown in FIGS. 1-4, first and second mounts 62, 64 are configured to pivotally couple the powertrain 40 to the frame 20a. The first and second mounts 62, 64 are arranged to be weight-bearing mounts such that the powertrain 40 hangs from the first and second mounts 62, 64.

The powertrain suspension system 60 may also include a third mount 66 configured to couple the powertrain 40 to the vehicle frame 20b where the third mount 66 is arranged to be a non-weight bearing mount. In the embodiment illustrated in FIGS. 1-4, the powertrain suspension system further includes a fourth mount 68 configured to couple the powertrain 40 to the vehicle frame 20 where the fourth mount 68 is also arranged to be a non-weight bearing mount.

As mentioned above, the inventors recognized that in an EV, it may be desirable to hang the powertrain from the frame of the vehicle. In particular, when the powertrain is pivotally coupled to the first and second mounts 62, 64, the powertrain is configured to pivot or swing relative to the vehicle frame. As mentioned above, an EV may be subjected to substantially instantaneous onset of high torque, and both positive and negative torque. Configuring the powertrain 40 such that it can pivot may help to dissipate the effects of such torque. As shown, the powertrain 40 may be configured to pivot about axis 100 which is above the powertrain 40 and in one embodiment; the axis 100 is directly above the powertrain 40.

In one embodiment, the first and second mounts 62, 64 are configured such that the powertrain can pivot at least approximately 3 degrees relative to the vehicle frame. In another embodiment, the first and second mounts 62, 64 are configured such that the powertrain can pivot at least approximately 2 degrees relative to the vehicle frame, and in yet another embodiment, the first and second mounts 62, 64 are configured such that the powertrain can pivot at least approximately 4 degrees relative to the vehicle frame. In another embodiment, the first and second mounts 62, 64 are configured such that the powertrain can pivot at least approximately 1 degree relative to the vehicle frame.

In one embodiment, the powertrain 40 extends downwardly from at least a portion of the vehicle frame 20a and the first and second mounts 62, 64 are configured such that the powertrain 40 can pivot about axis 100 both in a first direction (e.g., clockwise when viewed in the direction from the wheel 48), and in a second direction which is opposite the first direction (e.g., counterclockwise when viewed in the direction from the wheel 48). It is recognized that the powertrain 40 would pivot in the one direction when subjected to a positive torque and that the powertrain 40 would pivot in the other direction when subjected to a negative torque. Thus, such a configuration would help to dissipate the resulting effects of both positive and negative torque.

The powertrain may 40 include a plurality of components, such as, but not limited to a motor 42 and a transaxle 44. One of ordinary skill in the art would recognize that the motor 42 is the source of propulsive energy for the vehicle, and the transaxle 44 translates the rotational velocity of the motor into rotational velocity of the wheels 48 to propel the vehicle. As shown in the figures, the drive shaft 46 (which in this embodiment includes half-shafts) couples the transaxle 44 to the wheels 48.

It is contemplated that the powertrain components are positioned such that the combined center of gravity of the powertrain (i.e. the combined center of gravity of the motor 42 and transaxle 44) is approximately centered between the first and second mounts 62, 64. In one embodiment, the powertrain is at least approximately 170 pounds and in one embodiment, the transaxle is at least approximately 90 pounds and the motor is at least approximately 80 pounds. In another embodiment, the heaviest component of the powertrain 40 is centrally positioned between the first and second mounts 62, 64 and the other component(s) is/are positioned on one or both sides. For example, in one embodiment, the transaxle 44 is the heaviest component of the powertrain, and thus, the transaxle may be positioned generally equidistant from both the first and second mounts 62, 64. As shown in FIG. 1, the motor 42 may be positioned adjacent the transaxle 44. It is contemplated that in an embodiment with two motors, one motor may be positioned on each side of the transaxle and the transaxle may be centered between the first and second mounts 62, 64.

The powertrain 40 may be configured such that the net center of gravity of the powertrain components 40 is arranged to be directly below the axis 100 of rotation of the powertrain such that the non-weight bearing mounts 66, 68 are not preloaded when the vehicle is at rest.

It is contemplated that the powertrain is configured to hang from the first and second mounts 62, 64 via cross beam 70, such that the first and second mounts 62, 64 are configured to bear the weight of the powertrain. In one embodiment, the first and second mounts are constructed to bear a weight of at least approximately 170 lbs. In one embodiment, the first mount is constructed to bear at least approximately one half of the weight of the powertrain, and the second mount is constructed to bear at least approximately one half of the weight of the powertrain. For example, in one embodiment, the first and second mounts 62, 64 are each configured to bear a weight of at least approximately 90 lbs. In another embodiment, it is also contemplated that one of the first and second mounts 62, 64 is configured to bear more than approximately one half of the weight of the powertrain.

As mentioned above, the powertrain suspension system 60 may include one or more non-weight bearing mounts. For example, as illustrated in FIGS. 1-4, in one embodiment, the powertrain suspension system includes third and fourth mounts 66, 68 which couple the powertrain 40 to the vehicle frame 20, and both mounts 66, 68 are arranged to be non-weight bearing mounts. In particular, the powertrain suspension system is configured such that there is no downward force on the third and fourth mounts 66, 68. As discussed above, the powertrain essentially hangs from the first and second mounts 62, 64. In contrast, the third and fourth mounts 66, 68 are configured substantially for vibration isolation and to restrict the propulsive torque produced by the motor.

As shown in FIGS. 1-4, the third mount 66 is positioned on a first side of the powertrain, and the fourth mount 68 is positioned on a second side of the powertrain, opposite the first side. In this respect, the third mount 66 is positioned to isolate vibration when the hanging powertrain 40 pivots in a first direction, whereas the fourth mount 68 is positioned to isolate vibration when the hanging powertrain 40 pivots in the second direction. In one embodiment, one of the third and fourth mounts 66, 68 may be configured to dissipate vibration from positive torque and the other of the third and fourth mounts 66, 68 may be configured to dissipate vibration from negative torque. As illustrated, the first and second mounts 62, 64 may be coupled to an upper portion of the powertrain 40, and the third and fourth mounts 66, 68 may be coupled to a lower portion of the powertrain 40.

It should be appreciated that in one embodiment, a fourth mount 68 may not be provided as the invention is not necessarily limited in this respect. For example, in one embodiment, the powertrain suspension system 60 may only include the first, second and third mounts 62, 64, 66. In another embodiment, the powertrain suspension system may only include the first, second, and fourth mounts, 62, 64, 68.

In one embodiment, the powertrain suspension system 60 further includes a first cross beam 70 and the first and second mounts 62, 64 are coupled to the first beam 70. The first beam 70 may be substantially linear and at least a portion of the beam 70 may define the pivot axis 100 about which the powertrain 40 rotates. In one illustrative embodiment, there is an offset in the cross beam 70 such that only a portion of the beam defines the pivot axis. The powertrain suspension system 60 may further include a second beam 72 which may extend substantially perpendicular to the first beam 70 and the third mount 66 may be coupled to the second beam 72. The powertrain suspension system 60 may further include a third beam 74 and the fourth mount 68 may be coupled to the third beam 74. In one illustrative embodiment, the powertrain 40 hangs from the first beam 70, the second beam 72 is positioned on one side of the powertrain and the third beam 74 is positioned on a second side of the powertrain, opposite the first side. As shown in FIG. 2, a plurality of fasteners 76 may be provided to couple the transaxle 44 to the second beam 72, though other suitable arrangements for coupling or integrally forming the beams may be employed, as the present invention is not limited in this respect. As also shown in FIG. 2, one or more brackets 78 may extend downwardly from the first beam 70, and a plurality of fasteners 76 may be provided to couple the motor 42 to the first beam 70.

The mounts 62, 64, 66, 68 may be configured in a variety of ways, as the invention is not so limited. The mounts may include a resilient member configured to absorb noise and/or vibration so that the noise and/or vibration are not felt by the passengers in the vehicle. For example, in one embodiment, the first and second mounts 62, 64 are elastomeric bushing mounts which may be obtained from companies such as, but not limited to Trelleborg, Paulstra, or Elastometall. In one particular embodiment, the first mount 62 is a hydraulic style mount, and the second mount is a pivoting elastomeric mount. In one particular embodiment, the third and fourth mounts 66, 68 are elastomeric floating mounts which may be obtained from companies such as, but not limited to Trelleborg, Paulstra, or Elastometall. These non-weight bearing mounts may be configured to roll relative to the powertrain 40 to constrain movement and reduce vibration. Other types of mounts are also contemplated, including, but not limited to hydraulic & pneumatic isolators, dashpots, magnetostrictive, and variable-orifice dampers. One of ordinary skill in the art would recognize that a variety of types of mounts may be suitable for the applications described herein.

As illustrated in FIG. 6, in one embodiment, the first, second, third and fourth mounts 62, 64, 66, 68 are arranged to form substantially a tetrahedral shape. In other words, the location of the four mounts approximate the four apexes of a tetrahedron. Without being bound by theory, the inventors have discovered that such a configuration may provide desirable dampening characteristics to the EV. In one embodiment, the mounts 62, 64, 66, 68 may be arranged to form substantially a tetrahedral shape where the first and second mounts 62, 64 are weight bearing mounts such that the powertrain hangs from the first and second mounts. The inventors also contemplate other configurations where the mounts 62, 64, 66, 68 are arranged to form a substantially tetrahedral shape, as the invention is not necessarily limited to the tetrahedral shape in combination with a powertrain hanging from two mounts.

The inventors recognized that by arranging the first, second, third and fourth mounts 62, 64, 66, 68 to form substantially a tetrahedral shape and a line defining the first and second mounts 62, 64 may be substantially perpendicular to a line defining the third and fourth mounts 66, 68. The inventors contemplate that such a configuration may help to minimize vibration in an EV. As shown in FIG. 2, a line defining the first and second mounts 62, 64 may be aligned with the axis 100 of rotation, which as shown, may be substantially parallel to the drive shaft 46. As shown in FIG. 2, the third and fourth mounts 66, 68 are positioned on a line that is substantially perpendicular to the axis 100 of rotation. In one embodiment, the line defining the third and fourth mounts 66, 68 is oriented to be substantially parallel to the direction of vehicle movement.

The inventors recognized that in an embodiment where portions of the powertrain 40, such as the motor 42, are not exactly centered on the EV, that secondary effects, such as gyroscopic torque and steer effects, on the motor 42 may act to twist the powertrain 40. In one embodiment, such effects may cause the left portion of the powertrain 40 to pull to the right. The inventors contemplate that by orienting the mounts in this tetrahedral shape, the third and fourth mounts 66, 68 may help to oppose these secondary effects. In one embodiment, the third and fourth mounts 66, 68 are positioned close to the center of gravity of the EV to prevent rolling of the motor. In one particular embodiment, the components of the powertrain 40 are configured such that their net center of gravity is positioned at the approximate centroid of the tetrahedron.

Without being bound by theory, it is contemplated that this configuration enables the third and fourth mounts 66, 68 to oppose rotational torque and thus constrain roll of the powertrain 40 within a design specification of for example 2 degrees. In other words, one of the third and fourth mounts 66, 68 may be configured for vibration isolation and prevents the powertrain 40 from rotating excessively in a first direction, and the other of the third and fourth mounts 66, 68 may also be configured for vibration isolation and prevents the powertrain from rotating excessively in an opposite second direction.

The above described components may be made of a verity of materials including, but not limited to, steel, aluminum, magnesium, or composite. It is contemplated that the first beam 70, the second beam 72, and/or the third beam 74 is formed of a steel bar. In one embodiment, the first beam 70 has a diameter of at least approximately 1.75 inches. In one embodiment, the vehicle frame 20 is made from stamped steel.

It should be appreciated that various embodiments of the present invention may be formed with one or more of the above-described features. The above aspects and features of the invention may be employed in any suitable combination as the present invention is not limited in this respect. It should also be appreciated that the drawings illustrate various components and features which may be incorporated into various embodiments of the present invention. For simplification, some of the drawings may illustrate more than one optional feature or component. However, the present invention is not limited to the specific embodiments disclosed in the drawings. It should be recognized that the present invention encompasses embodiments which may include only a portion of the components illustrated in any one drawing figure, and/or may also encompass embodiments combining components illustrated in multiple different drawing figures.

It should be understood that the foregoing description of various embodiments of the invention are intended merely to be illustrative thereof and that other embodiments, modifications, and equivalents of the invention are within the scope of the invention recited in the claims appended hereto.

1. An electric vehicle, comprising:
a frame;
a powertrain;
a powertrain suspension system mounting the powertrain to the frame, the powertrain suspension system comprising:
first and second mounts cooperating to pivotally couple the powertrain to the frame, with the first and second mounts being weight bearing mounts such that the powertrain hangs from the first and second mounts; and
a third mount coupling the powertrain to the frame, the third mount being a non-weight bearing mount.

2. The electric vehicle of claim 1, wherein the powertrain comprises at least a motor and a transaxle.

3. The electric vehicle of claim 1, wherein the powertrain suspension system further comprises:
a fourth mount coupling the powertrain to the frame, the fourth mount being a non-weight bearing mount.

4. The electric vehicle of claim 3, wherein the third mount is positioned on a first side of the powertrain, and the fourth mount is positioned on a second side of the powertrain, opposite the first side.

5. The electric vehicle of claim 1, wherein the first and second mounts are configured such that the powertrain can pivot at least approximately 3 degrees relative to the frame.

6. The electric vehicle of claim 1, wherein the third mount is coupled to a lower portion of the powertrain.

7. The electric vehicle of claim 1, wherein the first and second mounts are coupled to an upper portion of the powertrain.

8. The electric vehicle of claim 1, wherein the powertrain suspension system further comprises:
a first beam;
a second beam coupled to the first beam, wherein the second beam extends substantially perpendicular to the first beam;
wherein the first and second mounts are coupled to the first beam, and the third mount is coupled to the second beam.

9. The electric vehicle of claim 8, wherein the powertrain suspension system further comprises:
a fourth mount coupling the powertrain to the frame, the fourth mount being a non-weight bearing mount; and
a third beam, wherein the fourth mount is coupled to the third beam.

10. The electric vehicle of claim 1, wherein the first and second mounts are constructed and arranged to bear a weight of at least approximately 170 lbs.

11. The electric vehicle of claim 1, wherein the first mount is constructed and arranged to bear at least approximately one half of the weight of the powertrain.

12. The electric vehicle of claim 10, wherein the first mount is constructed and arranged to bear a weight of at least approximately 90 lbs.

13. The electric vehicle of claim 1, wherein the second mount is constructed and arranged to bear at least approximately one half of the weight of the powertrain.

14. The electric vehicle of claim 12, wherein the second mount is constructed and arranged to bear a weight of at least approximately 90 lbs.

15. The electric vehicle of claim 3, wherein the first, second, third and fourth mounts are arranged in a substantially tetrahedral shape.

16. The electric vehicle of claim 15, further comprising a drive shaft, wherein a line defining the first and second mounts is substantially parallel to the drive shaft.

17. The electric vehicle of claim 16, wherein the line defining the first and second mounts is substantially perpendicular to a line defining the third and fourth mounts.

18. The electric vehicle of claim 17, wherein the powertrain is configured to propel the electric vehicle in a first vehicle direction, and wherein the line defining the third and fourth mounts is substantially parallel to the first vehicle direction.

19. The electric vehicle of claim 3, wherein the third and fourth mounts are oriented in a plane that is substantially perpendicular to a plane defining the first and second mounts.

20. An electric vehicle, comprising:
a frame;
a powertrain mounted to the frame;
a powertrain suspension system, comprising:
first and second mounts cooperating to pivotally couple the powertrain to the frame;
third and fourth mounts coupling the powertrain to the frame;
wherein the first, second, third and fourth mounts are arranged to form a substantially tetrahedral shape.

21. The electric vehicle of claim 20, wherein the powertrain suspension system further comprises:
a first beam;
a second beam coupled to the first beam, wherein the second beam extends substantially perpendicular to the first beam;
wherein the first and second mounts are coupled to the first beam, and the third mount is coupled to the second beam.

22. The electric vehicle of claim 20, wherein the third mount is a non-weight bearing mount.

23. The electric vehicle of claim 20, wherein the fourth mount is a non-weight bearing mount.

24. The electric vehicle of claim 20, further comprising a drive shaft, wherein a line defining the first and second mounts is substantially parallel to the drive shaft.

25. The electric vehicle of claim 24, wherein the line defining the first and second mounts is substantially perpendicular to a line defining the third and fourth mounts.

26. The electric vehicle of claim 25, wherein the powertrain is configured to propel the electric vehicle in a first vehicle direction, and wherein the line defining the third and fourth mounts is substantially parallel to the first vehicle direction.

27. The electric vehicle of claim 24, wherein the third mount is oriented in a plane that is substantially perpendicular to a line defining the first and second mounts.

28. The electric vehicle of claim 24, wherein the fourth mount is oriented in a plane that is substantially perpendicular to a line defining the first and second mounts.

29. The electric vehicle of claim 20, wherein the third and fourth mounts are oriented in a plane that is substantially perpendicular to a plane defining the first and second mounts.
